(19) United States
(12) Patent Application Publication
(10) Pub. No.: US 2022/0181679 A1
(43) Pub. Date: Jun. 9, 2022

(54) LITHIUM ION CONDUCTIVE MATERIAL AND METHOD FOR PRODUCING THE SAME

(71) Applicant: SCHOTT AG, Mainz (DE)

(72) Inventors: Meike SCHNEIDER, Taunusstein (DE); Sebastian LEUKEL, Mainz (DE); Jörg SCHUHMACHER, Kornwestheim (DE); Andreas ROTERS, Mainz (DE); Wolfgang SCHMIDBAUER, Mainz (DE)

(73) Assignee: SCHOTT AG, Mainz (DE)

(21) Appl. No.: 17/542,653

(22) Filed: Dec. 6, 2021

(30) Foreign Application Priority Data
Dec. 4, 2020 (EP) 20 020 589.6

(51) Int. Cl. H01M 10/0562; C03C 10/00; C03C 4/14; H01M 10/0525

(52) U.S. Cl. CPC H01M 10/0562; C03C 10/0054; C03C 4/14; C03B 32/02; H01M 2300/0077; C03C 2204/00; H01M 10/0525

(57) ABSTRACT

The present disclosure relates to a lithium ion conductive material, preferably a lithium ion conductive glass ceramic, the material including a garnet-type crystalline phase content and an amorphous phase content. The material has a sintering temperature of 1000° C. or lower, preferably 950° C. or lower and an ion conductivity of at least 1*10⁻⁵ S/cm, preferably at least 2*10⁻⁵ S/cm, preferably at least 5*10⁻⁵ S/cm, preferably at least 1*10⁻⁴ S/cm, and the amorphous phase content includes boron and/or a composition including boron.

### CROSS-REFERENCE TO RELATED APPLICATION

The present application claims priority under 35 U.S.C. § 119 to European Patent Application No. EP 20 020 589.6, filed on Dec. 4, 2020, which is herein incorporated by reference.

### BACKGROUND OF THE DISCLOSURE

### 1. Field of the Disclosure

The present disclosure relates to a lithium ion conductive material, preferably lithium ion conductive glass ceramic, said material comprising a garnet-type crystalline phase content and an amorphous phase content.

The present disclosure further relates to a method for providing a lithium ion conductive material.

The present disclosure even further relates to a component comprising a lithium ion conductive material.

The present disclosure even further relates to a battery, preferably an all solid-state battery, comprising a component.

Although applicable to any kind of lithium ion conductive material, the present disclosure will be described with regard to a lithium ion conductive glass ceramics.

### 2. Discussion of the Related Art

Lithium ion batteries have become important as energy source in particular in portable devices, like smartphones, laptops or the like. However, a disadvantage of lithium ion batteries is that the used organic electrolytes are liquids and can leak from the battery or even burn in the event of a short circuit, even more since these chemicals are often hazardous substances. Furthermore, the energy density of the lithium ion batteries is limited, since the use of lithium metal anodes is mostly not possible due to the lack of stability of the electrolyte. The lifetime of these batteries is also limited: Frequent charging and discharging processes may result in lithium dendrites, which can lead to a short circuit between the anode and cathode.

To overcome these problems, all solid-state batteries have been developed using solid-state electrolytes. Although numerous solid lithium ion conductors are known, there are only a few that have sufficient chemical and/or electrochemical stability to allow the use of lithium metal as an anode. These include lithium garnets and LiPON. The ionic conductivity of garnets, typically more than 10⁻⁴ S/cm at room temperature, is significantly higher than that of LiPON, which for this reason is mainly used in thin-film batteries.

However, high temperatures, typically above 1000° C., and/or long process times are required in the manufacture and processing of lithium garnets. This complicates, for example, the co-sintering with other battery materials such as cathode materials, because they are not stable at such high temperatures. In addition, these high temperature sintering steps often result in lithium evaporation, which in turn results in a decreased conductivity that has to be compensated by complex processes, e.g. covering/embedding the material in a “sacrificial material”, protection of the furnaces from the lithium vapor, compensation of evaporation in the weighed sample, or the like. A sintering step at low temperatures, on the other hand, does not lead to the conductivities required for a battery.

One solution to this problem is the use of sintering additives that are mixed with the ceramic ion-conducting powder, which gives rise to the problem of homogenization. In order to achieve a homogeneous mixture of the ion conductor and the sinter additive, additional mixing and grinding steps are necessary, which renders the production more expensive. If the mixture is not completely homogenized, e.g. by agglomeration, the sintered component comprises areas with different conductivity, which promote the formation of lithium dendrites and thus reduces the lifetime of the battery.

One of the problems addressed by embodiments of the present disclosure is to provide a lithium ion conductive glass ceramic, a component and a battery having a high conductivity and a low sintering temperature.

One of the further problems addressed by embodiments of the present disclosure is to provide a lithium ion conductive glass ceramic, a component and a battery having a homogeneous conductivity.

One of the further problems addressed by embodiments of the present disclosure is to provide a method for providing a lithium ion conductive glass ceramic, which can be easily implemented enabling a cheap production in a shorter time than conventional methods.

### SUMMARY OF THE DISCLOSURE

In an embodiment, the present disclosure provides a lithium ion conductive material, preferably a lithium ion conductive glass ceramic. Said glass ceramic comprising a garnet-type crystalline phase content and an amorphous phase content. Said glass ceramics has a sintering temperature of 1000° C. or lower, preferably 950° C. or lower, and an ion conductivity of at least 1*10⁻⁵ S/cm, preferably at least 2*10⁻⁵ S/cm, preferably at least 5*10⁻⁵ S/cm, preferably at least 1*10⁻⁴ S/cm, and said amorphous phase content comprises boron and/or a composition comprising boron.

In an embodiment, the present disclosure provides a method for providing a lithium ion conductive material, preferably a lithium ion conductive glass ceramic, according to one of the preceding paragraphs, comprising the steps of
Melting of precursor materials, preferably glass ceramic precursor materials to obtain a molten mass,
Homogenizing said molten mass, and
Cooling of said homogenized mass, preferably further ceramizing the cooled mass, to obtain a final mass in form of said lithium ion conductive material.

In an embodiment, the present disclosure provides a component comprising a material, preferably the lithium ion conductive glass ceramic previously described, preferably said component is a separator or an electrode of a battery or a membrane, preferably said material, preferably said glass ceramic according to one of the claims 1-9 is co-sintered with at least one is other material to obtain said component.

In an embodiment, the present disclosure provides a battery, preferably an all solid-state battery, comprising a component described herein.

One of the advantages is that a lithium ion conductive material, a component, and a battery is provided having a high conductivity and a low sintering temperature. One of the further advantages is that a lithium ion conductive material, a component, and a battery having a homogeneous conductivity is provided. One of the further advantages is that a method for providing a lithium ion conductive material is disclosed, which can be easily implemented enabling a cheap producing in a shorter time than conventional methods.

In other words, according to embodiments of the present disclosure, homogenization takes place in the melt, when producing the material, preferably the glass ceramic. During subsequent cooling, the lithium-ion conducting crystal phase crystallizes, which is surrounded by the amorphous residual glass phase. By adjusting the composition of the material as described in embodiments of the present disclosure, an amorphous phase can be formed, which can comprise essentially boron oxide, lithium oxide and optionally niobium oxide, silicon oxide, aluminum oxide and/or alkaline earth oxides and which both reduces lithium evaporation during sintering and permits a lowering of the sintering temperatures down to e.g. ≤1000° C., preferably 950° C. at conductivities of ≥2×10⁻⁵ S/cm. The glassy phase can surround the ion-conducting garnet crystals of the individual particles, so that homogeneity of the material down to the particle level may be achieved without further grinding or mixing processes. The production of such a material is also scalable on a large scale and may allow significantly shorter process times compared to solid-state synthesis.

Further features, advantages and further embodiments are described or may become apparent in the following.

According to an embodiment of the present disclosure, said amorphous phase content is below 35 vol-% of the total composition of said material, preferably between 0.5 vol-% and 30 vol-%, preferably between 0.5 vol-% and 10 vol-%, most preferably between 0.5 vol-% and 5 vol-%. One of the advantages is, that on the one hand the lower boundary ensures sufficient efficacy and on the other hand the upper boundary ensures that the garnet crystals can form a continuous network of highly conductive paths during sintering, i.e. represents a percolation threshold.

According to a further embodiment of the present disclosure, said amorphous phase content comprises lithium oxide and at least one doping agent, preferably at least one of based on niobium, aluminum, tantalum. One of the advantages can be that the stabilization of the cubic phase is enabled in a broader composition range. Use of Nb₂O₅ or Al₂O₃ may be preferred because it is cheaper than Ta₂O₅.

According to a further embodiment of the present disclosure, said garnet-type crystalline phase content is boron-free. One of the advantages is that the boron is concentrated in the amorphous phase ensuring low melting temperature of this phase and thus lowering the required sintering temperature of the material.

According to a further embodiment of the present disclosure, said material is free of at least one of
transition metals and compounds thereof and/or
alkali metals except lithium and compositions thereof and/or
halogenides and compositions thereof, and/or
selenium and compositions thereof, and/or
sulfur and compositions thereof, and/or
lead and compositions thereof, and/or
cadmium and compositions thereof, and/or
tellurium and compositions thereof.

This makes it possible to provide a material, preferably a glass ceramic free of toxic and highly volatile components.

According to a further embodiment of the present disclosure, said garnet-type crystalline phase having the sum formula of

Li_{7-3x+y-z}AlₓM_{y}^{II}M_{3-y}^{III}M_{2-z}^{IV}M_{z}^{V}O_{12±δ},

wherein M^{II} being a bivalent cation, M^{III} a trivalent cation, M^{IV} a quadrivalent cation and M^{V} a pentavalent cation and wherein x+z>0, preferably wherein said trivalent cation comprising an element of the lanthanides, preferably lanthanum, said quadrivalent cation comprising zircon and said pentavalent cation comprising niobium and/or tantalum and wherein δ<0.5 represents potential oxygen vacancies. An advantage can be that a sufficient stabilizing of the cubic crystalline phase is enabled.

According to a further embodiment of the present disclosure, said garnet-type crystalline phase is provided in form of a cubic garnet-type inorganic solid electrolyte, preferably niobium and/or aluminum doped Lithium Lanthanum Zirconium oxide, LLZO. This provides a high conductivity of the material, preferably glass ceramic.

According to a further embodiment of the present disclosure, said composition further comprises at least one refining agent, chosen from arsenic oxide, antimony oxide, cerium oxide, and/or tin oxide. This provides refining of the material, preferably in form of a glass ceramic if necessary.

According to a further embodiment of the present disclosure, the electronic conductivity is smaller than 10⁻⁵ S/cm, preferably smaller than 10⁻⁶ S/cm. One of the advantages can be that the self-discharge of the battery is reduced, e.g. when the material is used as a separator.

According to a further embodiment of the method, said final mass is milled to provide a powder. This enables in an easy way to provide a form of the glass ceramic for further processing, e.g. forming components.

According to a further embodiment of the method, the particles of said powder are provided with a particle size of d₅₀=10 micrometer or smaller, preferably of d₅₀=5 micrometer or smaller, preferably of d₅₀=2 micrometer or smaller, preferably of d₅₀=1 micrometer or smaller and said particles comprise the respective content parts of said material with a deviation of less than 50%, preferably of less than 30%, preferably of less than 20% regarding the content of each component of said material. This reduces the probability of areas of different conductivity in the further processing of the powder, e.g. sintering.

According to a further embodiment of the method, said powder is sintered with a sintering temperature below 1000° C., preferably below 950° C. Such low sintering temperatures reduce evaporation of lithium, therefore ensuring high conductivity and easy manufacturing of the glass ceramic with lower necessary resources.

There are several ways how to design and further develop the teachings of the present disclosure in an advantageous way. To this end, it is to be referred to the patent claims subordinate to the independent patent claims and to the following explanation of preferred examples of embodiments of the disclosure on the other hand. In connection with the explanation of the preferred embodiments of the disclosure, generally preferred embodiments and further developments of the teaching will be explained.

### BRIEF DESCRIPTION OF THE DRAWINGS

FIG. 1 shows steps of part of a method according to an embodiment of the present disclosure, showing method steps for providing a sintered component.

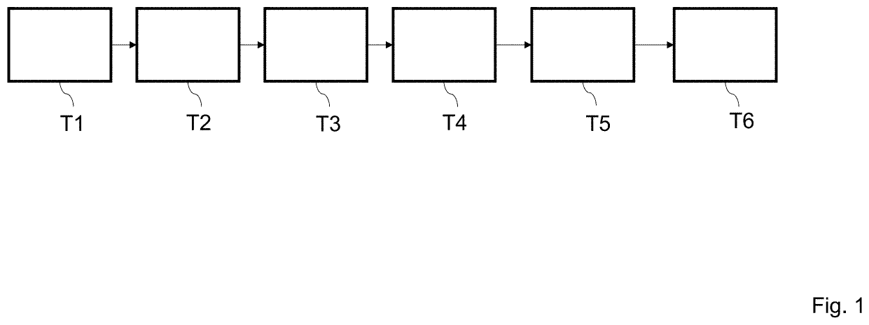

### DETAILED DESCRIPTION OF THE DISCLOSURE

In the following, a method for producing a glass ceramic according to an embodiment of the present disclosure is described.

Melting takes place in a so-called skull crucible, as described in DE 199 39 782 C1, which is herein incorporated by reference. The LLZO glass ceramics production is preferably according to methods as described in EP 3097060 B1, which is herein incorporated by reference.

The resulting glass-ceramics were used to produce samples for X-ray diffraction (XRD) investigations. In order to avoid degradation of the samples in contact with water, the sample preparation was carried out without water.

To determine the conductivity as a function of the sintering temperature, the material solidified as a solid block was further processed as follows:

In a first step T1, the block was cut into smaller fragments using a hammer and chisel. These were then fed into a jaw crusher in a further step T2 in one or more passes until fragments of a maximum size of less than 15 mm were produced in the longest dimension. These were ground in a further step T3 to a size d₉₉<2 mm on a disk mill.

The obtained coarsely ground powder, here LLZO powder, sintering at low temperatures with a particle size <2 mm was finely ground in a further step T4 on a pilot dry classifier mill. 10 wt.-% of the particles in the resulting powder had a diameter of less than 0.2-0.5 μm, 50 wt.-% had a diameter of less than 0.6-1.6 μm, 90 wt.-% had a diameter of less than 2.0-2.8 μm, and 99 wt.-% had a diameter of 3.2-4.8 μm.

The obtained finely ground powder was then pressed in a further step T5 into cylindrical specimens having a diameter of 10 mm and a thickness of 1 mm and then in a further step T6 sintered at various temperatures and holding times. This resulted in the relative densities and conductivity values for the corresponding sintered specimens listed in the table below.

| Example | 1* | 2* | 3 | 4 | 5 | 6 | 7 | 8 | 9 |
|---|---|---|---|---|---|---|---|---|---|
| Wt % | | | | | | | | | |
| Li₂O | 14.65 | 13.15 | 14.44 | 14.89 | 13.43 | 14.45 | 14.36 | 15.17 | 13.69 |
| La₂O₃ | 56.37 | 57.36 | 55.58 | 54.15 | 56.32 | 55.6 | 55.26 | 55.12 | 53.96 |
| ZrO₂ | 21.32 | 21.69 | 21.02 | 17.75 | 22.72 | 21.03 | 20.9 | 20.85 | 23.13 |
| SiO₂ | — | — | 0.21 | 0.2 | 0.21 | — | 0.21 | 0.2 | — |
| Al₂O₃ | — | — | — | — | — | 0.58 | — | — | 1.13 |
| Nb₂O₅ | 7.66 | 7.8 | 7.56 | 10.31 | 6.13 | 7.56 | 7.52 | 7.49 | — |
| Ta₂O₅ | — | — | — | — | — | — | — | — | 7.32 |
| B₂O₃ | — | — | 1.19 | 2.7 | 1.21 | 0.79 | 1.78 | 1.18 | 0.77 |
| Amorphous Phase | Li 2 | Li 1 | Li 2 | Li 2.7 | Li 1.2 | Li 2 | Li 2 | Li 2.5 | Li 1.6 |
| (calculated, cations (Li⁺, B³⁺, | | | B 0.3 | B 0.7 | B 0.3 | B 0.2 | B 0.45 | B 0.3 | B 0.2 |
| Al³⁺, Si⁴⁺, P⁵⁺) are | | | Si 0.03 | | Si 0.03 | Al 0.1 | Si 0.03 | Si 0.03 | Al 0.2 |
| charge balanced | | | | | | | | | |
| by oxygen (O²⁻), pfu) | | | | | | | | | |
| 1130° C., 0.5 h | | | | | | | | | |
| rel. density in % | 99.3 | 94.6 | 99.1 | 97.6 | 94.5 | 97 | | | 96.7 |
| conductivity | 8.0* | 6.4* | 5.24* | 2.1* | 4.5* | 6.7* | | | 4.8* |
| [S/cm] | 10⁻⁴ | 10⁻⁴ | 10⁻⁴ | 10⁻⁴ | 10⁻⁴ | 10⁻⁴ | | | 10⁻⁴ |
| 1000° C., 5 h | | | | | | | | | |
| rel. density in % | 63.9 | 66.8 | 90.5 | 88.9 | 86.2 | 96.3 | | | 89.3 |
| conductivity | 2.0E−06 | 5.0E−06 | 3.3* | 1.2* | 1.5* | 5.0* | | | 1.3* |
| [S/cm] | | | 10⁻⁴ | 10⁻⁴ | 10⁻⁴ | 10⁻⁴ | | | 10⁻⁴ |
| 900° C., 5 h | | | | | | | | | |
| rel. density in % | | | 76.7 | nb | 78.2 | 84.3 | 74.8 | 80 | 76.7 |
| conductivity | | | 8.0* | nb | 5.0* | 1.3* | 3.2* | 1.2* | 4.0* |
| [S/cm] | | | 10⁻⁵ | | 10⁻⁵ | 10⁻⁴ | 10⁻⁴ | 10⁻⁴ | 10⁻⁵ |

| Example | 10 | 11 | 12 | 13 | 14 | 15 | 16 |
|---|---|---|---|---|---|---|---|
| Wt % | | | | | | | |
| Li₂O | 14.50 | 15.17 | 12.22 | 14.53 | 12.94 | 12.42 | 12.47 |
| La₂O₃ | 55.81 | 55.16 | 51.41 | 55.92 | 50.11 | 50.77 | 50.99 |
| Gd₂O₃ | | | 5.30 | | 5.16 | 5.23 | 5.25 |
| Y₂O₃ | | | 0.66 | | 0.64 | 0.65 | 0.65 |
| ZrO₂ | 21.11 | 20.86 | 28.81 | 21.15 | 28.08 | 28.45 | 28.57 |
| SiO₂ | 0.21 | | | | 0.14 | 0.14 | 0.21 |
| Al₂O₃ | | 0.40 | 1.19 | | 1.74 | 1.76 | 1.77 |
| Nb₂O₅ | 7.59 | 7.50 | | 7.60 | | | |
| B₂O₃ | 0.79 | 0.90 | 0.41 | 0.80 | 1.19 | 0.16 | 0.08 |
| P₂O₅ | | | | | | 0.41 | |
| Amorphous Phase | Li 2 | Li 2.5 | Li 0.6 | Li 2 | Li 1.2 | Li 0.8 | Li 0.8 |
| (calculated, cations (Li⁺, | B 0.2 | B 0.23 | B 0.1 | B 0.2 | B 0.3 | B 0.04 | B 0.02 |
| B³⁺, Al³⁺, Si⁴⁺, P⁵⁺) are | Si 0.03 | Al 0.07 | | | Al 0.1 | Al 0.1 | Al 0.1 |
| charge balanced by oxygen | | | | | Si 0.02 | Si 0.02 | Si 0.03 |
| (O²⁻), pfu) | | | | | | P 0.05 | |
| 1130° C., 0.5 h | | | | | | | |
| rel. density in % | 94.0 | 96.3 | 96.5 | 98.5 | 99.4 | | |
| conductivity [S/cm] | 5.8* | 2.7* | 1.0* | 3.5* | 1.5* | | |
| | 10⁻⁴ | 10⁻⁴ | 10⁻⁴ | 10⁻⁴ | 10⁻⁴ | | |
| 1000° C., 5 h | | | | | | | |
| rel. density in % | | | | | | | |
| conductivity [S/cm] | | | | | | | |
| 900° C., 5 h | | | | | | | |
| rel. density in % | 83.2 | 85.0 | | 74.6 | | | |
| conductivity [S/cm] | 2.0* | 9.0* | | 5.0* | | | |
| | 10⁻⁴ | 10⁻⁵ | | 10⁻⁵ | | | |

The weighed-in composition of the examples according to embodiments of the present disclosure is summarized in Table 1 in percent by weight. The chemical analysis of the samples/examples may reveal additionally HfO₂, which is a common impurity in ZrO₂. Moreover, the Li₂O content can be reduced due to Li loss by evaporation during the synthesis.

The composition of the amorphous phase is calculated based on the composition of the glass ceramic by the following assumptions:

Li₂O, La₂O₃, Gd₂O₃, Y₂O₃, ZrO₂, Nb₂O₅, Ta₂O₅ form the stoichiometric garnet.

In the absence of Nb₂O₅ and Ta₂O₅, Al₂O₃ enters the garnet and substitutes Li₂O until 0.6 pfu Li+ are replaced by 0.2 pfu Al²⁺. Surplus Li₂O and Al₂O₃, as well as any SiO₂, B₂O₃ and P₂O₅ and further glass formers are ascribed to the amorphous phase. In other words, the given composition is divided into the stoichiometric garnet, which may contain several dopants,

Li_{7-3x+y-z}AlₓM_{y}^{II}M_{3-y}^{III}M_{2-z}^{IV}M_{z}^{V}O_{12±δ},

and an amorphous phase, which comprises the glass formers e.g. SiO₂, B₂O₃, Al₂O₃, and P₂O₅, as well as surplus Li₂O. Divalent ions M^{II} would be ascribed to the crystalline garnet for the sake of clarity, even though the one skilled in the art is aware that divalent cations can also act as glass formers and would be found at least partially in the amorphous phase. It is to be understood that this calculation does not give a precise, actual composition of the amorphous phase, which can deviate due the assumptions made in this calculation and Li loss during the synthesis, but more so elucidates its compositional range and highlights the influence of boron in this phase on the sintering behavior. The composition of the amorphous phase in the Table above is given in pfu (parts per formula unit) with regard to LLZO. The amorphous phase is oxidic and thus the elements/cations are charge-balanced by oxygen (O²⁻).

Comparative Examples 1* and 2* correspond to the previous state of the art with a glass phase without boron.

In Example 1* and 2*, the amorphous phase, calculated by subtracting all components that can crystallize as stoichiometric garnet, comprises only Li₂O. Based on a theoretical garnet structure in example 1*, there are 2 mol Li per formula unit, in Example 2*, there is only 1 mol Li per formula unit. In both cases, good conductivities are found during sintering at 1130° C., but even if the sintering temperature is lowered to 1000° C., the sintering temperature drops to below 10⁻⁵ S/M.

In contrast, Examples 3-16 show the effect of high conductivity at low sintering temperatures according to embodiments of the present disclosure. In addition to the conductivities and density at sintering temperatures of 1130° C., 1000° C., and 900° C., the calculated composition of the amorphous phase is also presented. It can be seen that for all glass ceramics comprising boron in the amorphous phase, conductivities in the order of 10⁻⁴ S/cm are achieved at sintering temperatures of 1000° C. Even if the sintering temperatures are further reduced to 900° C., the conductivities are still in the range of 3.2×10⁻⁵ S/cm to 1.3×10⁻⁴ S/cm providing a high conductivity compared to conventional glass ceramics.

To summarize, embodiments of the present disclosure provides and/or enables the following features and/or advantages:
low sintering temperature
easy and cheap manufacturing
easy implementation
less resources necessary
high conductivity
scalability
reduced manufacturing time

Many modifications and other embodiments of the disclosure set forth herein will come to mind to the one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### LIST OF REFERENCE SIGNS

T1-T6 Steps of part of a method

1. A lithium ion conductive material comprising:
a garnet-type crystalline phase; and
an amorphous phase,
wherein the material has a sintering temperature of 1000° C. or lower, and an ion conductivity of at least 1*10⁻⁵ S/cm, and
wherein the amorphous phase comprises boron and/or a composition comprising boron.

2. The lithium ion conductive material according to claim 1, wherein the lithium ion conductive material is lithium ion conductive glass ceramic.

3. The lithium ion conductive material according to claim 1, wherein the amorphous phase is less than 35 vol-% of the total composition of the material.

4. The lithium ion conductive material according to claim 1, wherein the amorphous phase is between 0.5 vol-% and 5 vol-% of the total composition of the material.

5. The lithium ion conductive material according to claim 1, wherein the amorphous phase content comprises lithium oxide and at least one doping agent.

6. The lithium ion conductive material according to claim 5, wherein the doping agent is at least one of based on niobium, aluminum, tantalum.

7. The lithium ion conductive material according to claim 1, wherein the garnet-type crystalline phase is boron-free.

8. The lithium ion conductive material according to claim 1, wherein the material is free of at least one of:
transition metals and compounds thereof,
alkali metals except lithium and compositions thereof,
halogenides and compositions thereof,
selenium and compositions thereof,
sulfur and compositions thereof,
lead and compositions thereof,
cadmium and compositions thereof, and
tellurium and compositions thereof.

9. The lithium ion conductive material according to claim 1, wherein the garnet-type crystalline phase has the formula:
Li_{7-3x+y-z}AlₓM_{y}^{II}M_{3-y}^{III}M_{2-z}^{IV}M_{z}^{V}O_{12±δ},
wherein M^{II} is a bivalent cation, M^{III} is a trivalent cation, M^{IV} is a quadrivalent cation and M^{V} is a pentavalent cation,
wherein x+z>0, and
wherein δ<0.5 represents potential oxygen vacancies.

10. The lithium ion conductive material according to claim 9, wherein the trivalent cation comprises a lanthanide, and wherein the quadrivalent cation comprises zircon and the pentavalent cation comprising niobium and/or tantalum.

11. The lithium ion conductive material according to claim 1, wherein the garnet-type crystalline phase is a cubic garnet-type inorganic solid electrolyte.

12. The lithium ion conductive material according to claim 12, wherein the cubic garnet-type inorganic solid electrolyte is lithium lanthanum zirconium oxide (LLZO) doped with at least one of niobium and aluminum.

13. The lithium ion conductive material according to claim 1, wherein the amorphous phase comprises the composition comprising boron, and
wherein the composition further comprises at least one refining agent selected from the group consisting of arsenic oxide, antimony oxide, cerium oxide, tin oxide, and any combinations thereof.

14. The lithium ion conductive material according to claim 1, wherein the material has a sintering temperature of 950° C. or lower.

15. The lithium ion conductive material according to claim 1, wherein the material has an ion conductivity of at least 1*10⁻⁴ S/cm.

16. The lithium ion conductive material according to claim 1, wherein the material has an electronic conductivity that is smaller than 10⁻⁵ S/cm.

17. The lithium ion conductive material according to claim 1, wherein the material has an electronic conductivity that is smaller than 10⁻⁶ S/cm.

18. A method for providing the lithium ion conductive material of claim 1, comprising the steps of;
melting precursor materials to obtain a molten mass;
homogenizing the molten mass; and
cooling of the homogenized molten mass to obtain a final mass in form of the lithium ion conductive material.

19. The method of claim 18, wherein the cooling step comprises ceramizing the cooled mass.

20. The method according to claim 18, further comprising the step of milling the final mass provide a powder.

21. The method according to claim 20, wherein the particles of the powder have a particle size of d₅₀=10 micrometer or smaller, and wherein the particles comprise the respective content parts of the material with a deviation of less than 50% of the content of each component of the material.

22. The method of claim 21, wherein the particles of the powder have a particle size of d₅₀=1 micrometer or smaller.

23. The method of claim 21, wherein the particles comprise the respective content parts of the material with a deviation of less than 20% of the content of each component of the material

24. The method according to claim 20, further comprising the step of sintering the powder at a temperature below 1000° Celsius.

25. A component comprising a material according to claim 1, wherein the component is a separator of a battery, an electrode of a battery, or a membrane, and wherein the material of claim 1 is co-sintered with at least one other material to obtain the component.

26. A battery comprising a component according to claim 25.
